(19) United States
(12) Patent Application Publication
(10) Pub. No.: US 2020/0134455 A1
(43) Pub. Date: Apr. 30, 2020

(54) APPARATUS AND METHOD FOR TRAINING DEEP LEARNING MODEL

(71) Applicant: SAMSUNG SDS CO., LTD., Seoul (KR)

(72) Inventors: Young-Joon Choi, Seoul (KR); Jong-Won Choi, Seoul (KR); Ji-Hoon Kim, Seoul (KR)

(21) Appl. No.: 16/665,792

(22) Filed: Oct. 28, 2019

(30) Foreign Application Priority Data
Oct. 31, 2018 (KR) 10-2018-0131610

(51) Int. Cl. G06N 3/08; G06N 3/04

(52) U.S. Cl. CPC G06N 3/08; G06N 3/0454

(57) ABSTRACT

An apparatus and method for training a deep learning model are provided. According to the disclosed embodiments, a deep learning model may be trained using learning data regarding problems of various fields so that there is an ample amount of data on which the model is trained and the performance of the trained model can be improved.

### CROSS-REFERENCE TO RELATED APPLICATION(S)

This application claims the benefit under 35 USC §119(a) of Korean Patent Application No. 10-2018-0131610, filed on Oct. 31, 2018, in the Korean Intellectual Property Office, the entire disclosure of which is incorporated herein by reference for all purposes.

### BACKGROUND

### 1. Field

The following description relates to a technology for training a deep learning model.

### 2. Description of Related Art

In problem-solving using a deep learning model, in order to solve a variety of problems, prior art requires a model for each of the corresponding problems. Such prior art causes various problems.

In the prior art, the number of models increases with the increasing number of problems, and hence it is difficult to manage a plurality of models. Also, as the number of models increases, duplicated models are generated, which causes a waste of computing resources used for the model. In addition, in the prior art, when an amount of learning data on which a model is trained is not sufficient, the performance of the model is degraded.

Therefore, there is a demand for a deep learning model that can solve various types of problems and can be easily trained on a new problem.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide an apparatus and method for training a deep learning model.

In one general aspect, a method of training a deep learning, which is performed by a computing device which includes one or more processors and a memory in which one or more programs to be executed by the one or more processors are stored, includes training a feature block including a generative model using a plurality of learning data, extracting a first feature value for each of the plurality of learning data using the trained feature block, training a domain block associated with each of the plurality of learning data among a plurality of domain blocks using the first feature value as learning data, extracting a second feature value for each of the plurality of learning data using the trained domain block, and training a specialty block associated with each of the plurality of learning data, among a plurality of specialty blocks, which are connected to each of the plurality of domain blocks, using the second feature value.

The training of the feature block may include extracting an initial feature value for each of the plurality of learning data using a pre-trained feature extraction model and training the generative model using the initial feature value as learning data of the generative model and on the basis of a loss function which is set up in the generative model.

The training of the feature block may include determining a parameter of the trained generative model to be a parameter of the feature block.

The extracting of the first feature value may include extracting the first feature value using the parameter of the trained generative model.

The training of the domain block may include training each of the plurality of domain blocks such that a result value of a loss function set up in each of the plurality of domain blocks is minimized, wherein the result value of the loss function set up in each of the plurality of domain blocks corresponds to a sum of result values of loss functions, each of which is set up in each of the plurality of specialty blocks connected to each of the plurality of domain blocks.

The domain block may include a middle-level layer and a knowledge scaling layer.

The training of the domain block may include training the middle-level layer included in each of the plurality of domain blocks using the first feature value for learning data associated with each of the plurality of domain blocks as learning data of the middle-level layer included in each of the plurality of domain blocks.

The extracting of the second feature value may include extracting the second feature value using a parameter of the trained middle-level layer.

The training of the domain block may include training the knowledge scaling layer connected to each of the plurality of domain blocks using the second feature value, which is extracted using the parameter of the trained middle-level layer, as learning data of the knowledge scaling layer connected to each of the plurality of domain blocks.

The training of the feature block may include adjusting a parameter of the trained feature block for the domain block including the trained knowledge scaling layer on the basis of a scaling value of the trained knowledge scaling layer.

The training of the domain block may include re-training each of the plurality of domain blocks using a domain adversarial neural network and on the basis of a loss function set up in the domain adversarial neural network.

The training of the specialty block may include training a mask layer included in each of the plurality of specialty blocks and on the basis of a loss function set up in each of the plurality of specialty blocks and using the second feature value as learning data of the mask layer.

The mask layer may include a positive mask layer that extracts a feature value for learning data associated with the specialty block among learning data that are learned in the domain block connected to the specialty block and a negative mask layer that extracts a feature value for learning data that has a negative effect on the specialty block among learning data that are learned in the domain block connected to the specialty block.

The method may further include, when new learning data that is not included in the plurality of learning data is input, determining whether a problem provided by the new learning data is a previously learned problem.

The method may further include, when the problem provided by the new learning data is not a previously learned problem, determining a domain block associated with the new learning data, generating a new specialty block associated with the new learning data and connecting the new specialty block to the determined domain block, and training the determined domain block and the new specialty block using the new learning data.

The method of claim 14, further comprising, when the problem provided by the new learning data is a previously learned problem, re-training a domain block and a specialty block that are associated with the previously learned problem using the new learning data.

In another general aspect, an apparatus for training a deep learning model includes one or more processors, a memory, and one or more programs, wherein the one or more programs are stored in the memory and are configured to be executed by the one or more processors and the one or more programs include commands for training a feature block including a generative model using a plurality of learning data, extracting a first feature value for each of the plurality of learning data using the trained feature block, training a domain block associated with each of the plurality of learning data among a plurality of domain blocks using the first feature value as learning data, extracting a second feature value for each of the plurality of learning data using the trained domain block, and training a specialty block associated with each of the plurality of learning data, among a plurality of specialty blocks, which are connected to each of the plurality of domain blocks, using the second feature value.

The training of the feature block may include extracting an initial feature value for each of the plurality of learning data using a pre-trained feature extraction model and training the generative model using the initial feature value as learning data of the generative model and on the basis of a loss function which is set up in the generative model.

The training of the feature block may include determining a parameter of the trained generative model to be a parameter of the feature block.

The extracting of the first feature value may include extracting the first feature value using the parameter of the trained generative model.

The training of the domain block may include training each of the plurality of domain blocks such that a result value of a loss function set up in each of the plurality of domain blocks is minimized, wherein the result value of the loss function set up in each of the plurality of domain blocks corresponds to a sum of result values of loss functions, each of which is set up in each of the plurality of specialty blocks connected to each of the plurality of domain blocks.

The domain block may include a middle-level layer and a knowledge scaling layer.

The training of the domain block may include training the middle-level layer included in each of the plurality of domain blocks using the first feature value for learning data associated with each of the plurality of domain blocks as learning data of the middle-level layer included in each of the plurality of domain blocks.

The extracting of the second feature value may include extracting the second feature value using a parameter of the trained middle-level layer.

The training of the domain block may include training the knowledge scaling layer connected to each of the plurality of domain blocks using the second feature value, which is extracted using the parameter of the trained middle-level layer, as learning data of the knowledge scaling layer connected to each of the plurality of domain blocks.

The training of the feature block may include adjusting a parameter of the trained feature block for the domain block including the trained knowledge scaling layer on the basis of a scaling value of the trained knowledge scaling layer.

The training of the domain block may include re-training each of the plurality of domain blocks using a domain adversarial neural network and on the basis of a loss function set up in the domain adversarial neural network.

The training of the specialty block may include training a mask layer included in each of the plurality of specialty blocks and on the basis of a loss function set up in each of the plurality of specialty blocks and using the second feature value as learning data of the mask layer.

The mask layer may include a positive mask layer that extracts a feature value for learning data associated with the specialty block among learning data that are learned in the domain block connected to the specialty block and a negative mask layer that extracts a feature value for learning data that has a negative effect on the specialty block among learning data that are learned in the domain block connected to the specialty block.

The one or more programs may further include commands for, when new learning data that is not included in the plurality of learning data is input, determining whether a problem provided by the new learning data is a previously learned problem.

The one or more programs may further include commands for, when the problem provided by the new learning data is not a previously learned problem, determining a domain block associated with the new learning data, generating a new specialty block associated with the new learning data and connecting the new specialty block to the determined domain block, and training the determined domain block and the new specialty block using the new learning data.

The one or more programs may further include commands for, when the problem provided by the new learning data is a previously learned problem, re-training a domain block and a specialty block that are associated with the previously learned problem using the new learning data.

Other features and aspects will be apparent from the following detailed description, the drawings, and the claims.

### BRIEF DESCRIPTION OF THE DRAWINGS

FIG. 1 is a block diagram for describing a computing environment including a computing device suitable to be used in exemplary embodiments.

FIG. 2 is a diagram illustrating a configuration of a deep learning model according to one embodiment.

FIG. 3 is a diagram for describing a connection relationship among domain blocks, a feature block, and a domain adversarial neural network according to one embodiment.

FIG. 4 is a flowchart illustrating a method of training a deep learning model according to one embodiment.

FIG. 5 is a flowchart illustrating a method of training a feature block according to one embodiment.

FIG. 6 is a diagram for describing an example of training the feature block using an autoencoder according to one embodiment.

FIG. 7 is a flowchart illustrating a method of training the domain block according to one embodiment.

FIG. 8 is a flowchart illustrating a method of training a deep learning model according to an additional embodiment.

FIG. 9 is a diagram for describing an example of training a deep learning model according to one embodiment.

FIG. 10 is a diagram illustrating a configuration of the deep learning model according to one embodiment.

FIG. 11 is a diagram for describing another example of training the deep learning model according to one embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

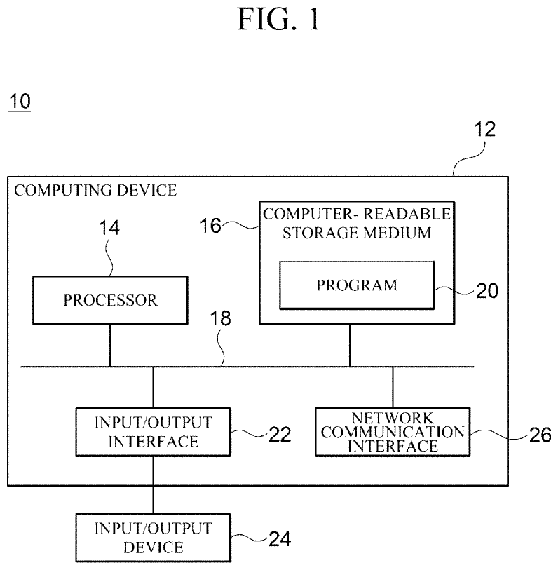

FIG. 1 is a block diagram for describing a computing environment 10 including a computing device suitable to be used in exemplary embodiments. In the illustrated embodiments, each of the components may have functions and capabilities different from those described hereinafter and additional components may be included in addition to the components described herein.

The illustrated computing environment 10 includes a computing device 12. In one embodiment, the computing device 12 may be an apparatus for training a deep learning model according to exemplary embodiments. The computing device 12 may include at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable commands, and the computer executable commands may be configured to, when executed by the processor 14, cause the computing device 12 to perform operations according to an exemplary embodiment.

The computer-readable storage medium 16 is configured to store computer executable commands and program codes, program data and/or information in other suitable forms. The program 20 stored in the computer-readable storage medium 16 may include a set of commands executable by the processor 14. In one embodiment, the computer-readable storage medium 16 may be a memory (volatile memory, such as random access memory (RAM), non-volatile memory, or a combination thereof), one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer-readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24, which is one component constituting the computing device 12, may be included inside the computing device 12 or may be configured as a device separate from the computing device 12 and be connected to the computing device 12.

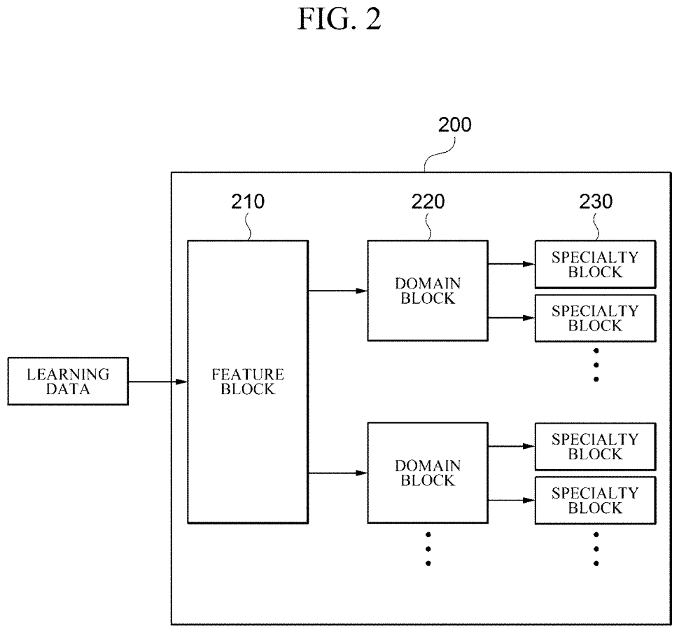

FIG. 2 is a diagram illustrating a configuration of a deep learning model 200 according to one embodiment.

The deep learning model 200 may be trained by a method of training a deep learning model according to exemplary embodiments.

Referring to FIG. 2, the deep learning model 200 includes a feature block 210, domain blocks 220, and specialty blocks 230.

The feature block 210, the domain blocks 220, and the specialty blocks 230 may each be a neural network including a plurality layers.

In a neural network, artificial neurons that simplify functions of biological neurons and the artificial neurons may be connected to each other via connection lines having connection weights. The connection weight, which is a parameter the neural network, is a specific value of a connection line and may be referred to as connection strength. The neural network may perform human cognitive process or learning process through artificial neurons. The artificial neuron may be referred to as a node.

The neural network may include a plurality of layers. For example, the neural network may include an input layer, a hidden layer, and an output layer. The input layer may receive a signal for performing learning and forward the signal to the hidden layer and the output layer may generate an output of the neural network on the basis of signals received from nodes of the hidden layer. The hidden layer is interposed between the input layer and the output layer and may convert learning data delivered from the input layer into a value that is easy to predict. Nodes included in the input layer and the hidden layer may be connected to each other via connection lines having connection weights and the nodes included in the hidden layer and the output layer may be connected to each other via connection lines having connecting weights. The input layer, hidden layer, and the output layer may each include a plurality of nodes.

The neural network may include a plurality of hidden layers. The neural network including a plurality of hidden layers is referred to as a deep neural network and training the deep neural network is referred to as deep learning. A node included in the hidden layer is referred to as a hidden node. Hereinafter, training a neural network may be construed as training a parameter of the neural network. In addition, the trained neural network may be construed as a neural network to which the trained parameter is applied.

In this case, the neural network may be trained using a predetermined loss function as an indicator. The loss function may be an indicator for the neural network to determine an optimal weight parameter through training. The neural network may be trained with the goal of minimizing a result value of the set loss function.

The neural network may be trained through a supervised learning scheme or an unsupervised learning scheme. Supervised learning is a method in which learning data and output data that corresponds to the learning data are input together to a neural network and connection weights of connection lines are updated such that output data that correspond to the learning data is output. Unsupervised learning is a method in which only learning data is input to a neural network without output data that correspond to the learning data and connection weights of connecting lines are updated to figure out features or a structure of the learning data.

The feature block 210 may be a neural network that learns a plurality of learning data and extracts a feature value of specific data. In this case, the feature block 210 may be connected to a plurality of domain blocks 220. Accordingly, the feature block 210 may learn sets of data on various problems regardless of a type of the problem and thus the feature block 210 may acquire a larger amount of information than information that can be obtained from data on one problem.

The domain block 220 may be a neural network that extracts feature values of pieces of learning data regarding problems having similar characteristics, among a plurality of learning data, on the basis of each of the plurality of learning data and the type of a problem. Accordingly, the domain block 220 may be trained on the data regarding problems having similar characteristics and hence may extract an accurate feature value for a corresponding problem.

According to one embodiment, the domain block 220 may include a middle-level layer and a knowledge scaling layer.

The middle-level layer may be a general layer constituting the neural network. In this case, the domain block 220 may extract a feature value of learning data using a parameter of the trained middle-level layer.

The knowledge scaling layer may acquire a scaling value for a specific domain to which the knowledge scaling layer belongs on the basis of a parameter of the middle-level layer. In this case, when the feature block 210 extracts a feature value for learning data associated with a specific domain block to which the knowledge layer having the scaling value belongs, the scaling value may serve to increase a weight for a feature value highly relevant to the specific domain and to reduce a weight for a feature value less relevant to the specific domain.

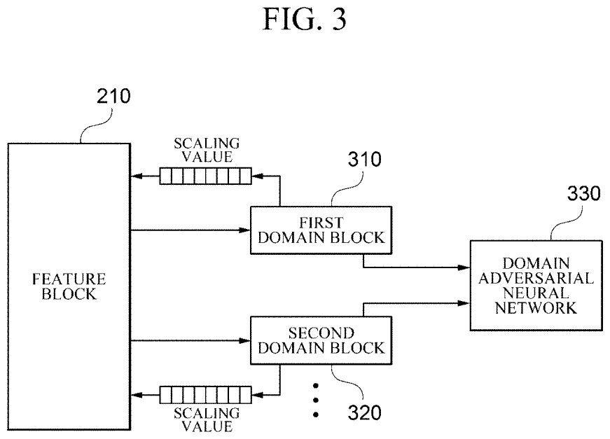

FIG. 3 is a diagram for describing a connection relationship among domain blocks, a feature block, and a domain adversarial neural network according to one embodiment.

Referring to FIG. 3, it is assumed that a first domain block 310 and a second domain block 320 have been trained such that knowledge scaling layers included in the domain blocks 310 and 320 have acquired scaling values for each of the domain blocks 310 and 320.

In the case of extracting a feature value for learning data associated with each of the first domain block 310 and the second domain block 320, the feature block 210 may extract the feature value for the learning data associated with each of the domain blocks 310 and 320 on the basis of a scaling value for each of the domain blocks 310 and 320.

Although FIG. 3 illustrates that there are two domain blocks, the number of domain blocks is not necessarily limited thereto, and may be set variously.

Referring back to FIG. 2, the domain block 220 may be connected to a plurality of specialty blocks 230.

The specialty block 230 may be a neural network that partitions a problem associated with the domain blocks 220 into a plurality of sub-problems and extracts feature values of learning data associated with each of the plurality of sub-problems. Accordingly, the specialty block 230 may learn data associated with the partitioned sub-problems and thus extract an accurate feature value for the partitioned sub-problems.

The specialty block 230 may include a mask layer that applies a weight to data regarding a problem to be learned in the corresponding specialty block 230 among pieces of data included in the domain block 220.

The mask layer may serve to extract pieces of data regarding a problem that the specialty block 230 should intensively focus on from among pieces of data included in the domain block 220 or to extract pieces of data regarding a problem that the specialty block 230 does not have to intensively focus on.

In this case, according to one embodiment, the mask layer may include a positive mask layer that extracts a feature value for learning data associated with the specialty block 230 among learning data that are learned in the domain block 220 connected to the specialty block 230 and a negative mask layer that extracts a feature value for learning data that has a negative effect on the specialty block 230 among learning data that are learned in the domain block 220 connected to the specialty block 230.

The specialty block 230 may use various learning methods on the basis of the type of problem to be solved.

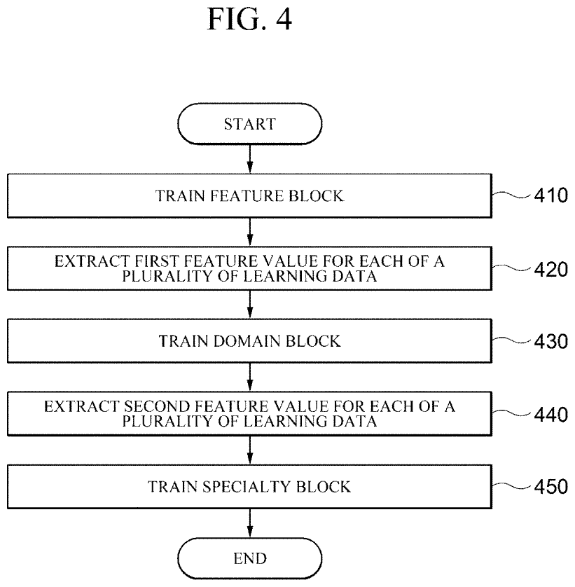

FIG. 4 is a flowchart illustrating a method of training a deep learning model according to one embodiment.

The method illustrated in FIG. 4 may be performed by, for example, a computing device 12 which includes one or more processors and a memory in which one or more programs to be executed by the one or more processors are stored. In the illustrated flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

Referring to FIG. 4, the computing device 12 may train a feature block 210 that includes a generative model using a plurality of learning data (410). In this case, the feature block 210 may be trained through, for example, an unsupervised learning scheme.

The plurality of learning data may include learning data regarding various types of problems. Thus, each learning data may be learning data regarding a different type of problem. Also, each learning data may include a plurality of learning samples on the pertinent problem. In this case, the learning data may include sequential data, such as voice data, image data, biometric data, handwriting data, or the like.

The generative model may be a model that generates a sample data set by learning a probability distribution of the learning data. The generative model may include, for example, an autoencoder, generative adversarial networks, and the like.

Then, the computing device 12 extracts a first feature value for each of the plurality of learning data using the trained feature block 210. In this case, the computing device 12 may extract the first feature value for each of the plurality of learning data using a parameter of the trained feature block 210.

Then, the computing device 12 trains a domain block 220 associated with each of the plurality of learning data among a plurality of domain blocks 220 using the first feature value as learning data (430). In this case, the domain block 220 may be trained through, for example, a supervised learning scheme.

In this case, according to one embodiment, the computing device 12 may train each of the plurality of domain blocks 220 such that a result value of a loss function which is set up in each of the plurality of domain blocks 220 is minimized, wherein the result value of the loss function that is set up in each of the plurality of domain blocks 220 may correspond to a sum of result values of loss functions each of which is set up in each of a plurality of specialty blocks 230 connected to each of the plurality of domain blocks 220.

Then, the computing device 12 extracts a second feature value for each of the plurality of learning data using the trained domain block 220 (440).

According to one embodiment, the computing device 12 may extract the second feature value using a parameter of a middle-level layer included in the domain block 220.

Also, according to one embodiment, the computing device 12 may adjust a parameter of the feature block 210 for the learning data associated with the domain block 220 including a trained knowledge scaling layer, on the basis of a scaling value of the trained knowledge scaling layer included in the domain block 220.

According to one embodiment, the computing device 12 may re-train each of the plurality of domain blocks 220 using a domain adversarial neural network 330 and on the basis of a loss function that is set up in the domain adversarial neural network 330.

The domain adversarial neural network 330 may be a neural network for preventing each domain block 220 from overfitting. The domain adversarial neural network 330 may be a neural network which is trained on the basis of, for example, a domain adaptation scheme.

In addition, the domain adversarial neural network 330 may include a domain classifier. The domain classifier may determine whether it is true or false that a learning sample input to the domain adversarial neural network 330 relates to the domain block 220 currently being trained.

In this case, referring to FIG. 3, the domain adversarial neural network 330 may be connected to the plurality of domain blocks 310 and 320.

The domain adversarial neural network 330 may train the plurality of domain blocks 310 and 320 such that a result value of a set loss value is minimized. In this case, the loss function set up in the domain adversarial neural network 330 may be represented by Equation 1 below.

$${min}_{D} {max}_{G} {\sum }_{i = 1}^{N} {L}_{softmax} ( D ( G ( {X}_{i} ) ) ) + λ {L}_{softmax} ( 1 - D ( G ( {X}_{i} ) ) ) \qquad ( 1 )$$

In Equation 1, D denotes a domain classifier, G denotes a domain block, L_{softmax} denotes a result value of a loss function set up in a trained domain classifier, Xᵢ denotes an ith learning sample, and λ denotes a regularization parameter.

Referring back to FIG. 4, the computing device 12 trains the specialty block 230 associated with each of the plurality of learning data, among the plurality of specialty blocks 230 included in each of the plurality of domain blocks 220, using the second feature value. In this case, the specialty block 230 may be trained through, for example, a supervised learning scheme.

According to one embodiment, the computing device 12 may train a mask layer included in each of the plurality of specialty blocks 230 using the second feature value for each learning data as learning data of the mask layer such that a result value of a loss function which is set up in each of the plurality of specialty blocks is minimized.

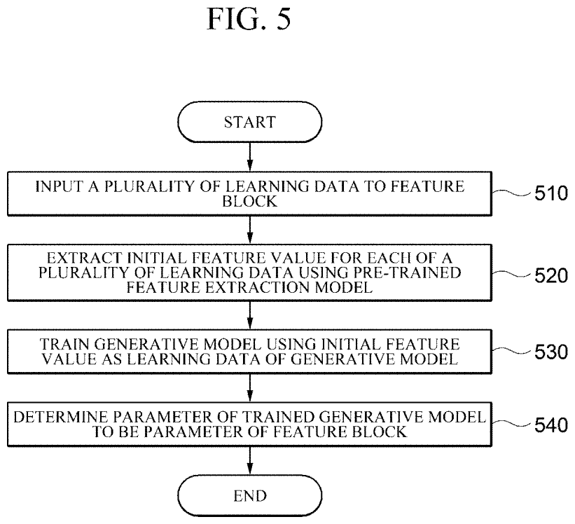

FIG. 5 is a flowchart illustrating a method of training a feature block 210 according to one embodiment.

The method illustrated in FIG. 5 may be performed by, for example, a computing device 12 which includes one or more processors and a memory in which one or more programs to be executed by the one or more processors are stored. In the illustrated flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

Referring to FIG. 5, the computing device 12 may input a plurality of learning data to the feature block 210 (510).

Then, the computing device 12 may extract an initial feature value for each of the plurality of learning data using a pre-trained feature extraction model (520).

In this case, the pre-trained feature extraction model may be a deep learning model that extracts a feature value for specific data on the basis of learning data, such as ImageNet dataset or the like. The pre-trained feature extraction model may be used for preprocessing each learning data before the plurality of learning data are input to a generative model.

The feature value may represent a feature of learning data as a vector value.

Then, the computing device 12 may train the generative model using the initial feature value as learning data of the generative model and on the basis of a loss function that is set up in the generative model (530). In this case, the loss function may vary depending on the type of the generative model.

Then, the computing device 12 may determine a parameter of the trained generative model to be a parameter of the feature block 210 (540).

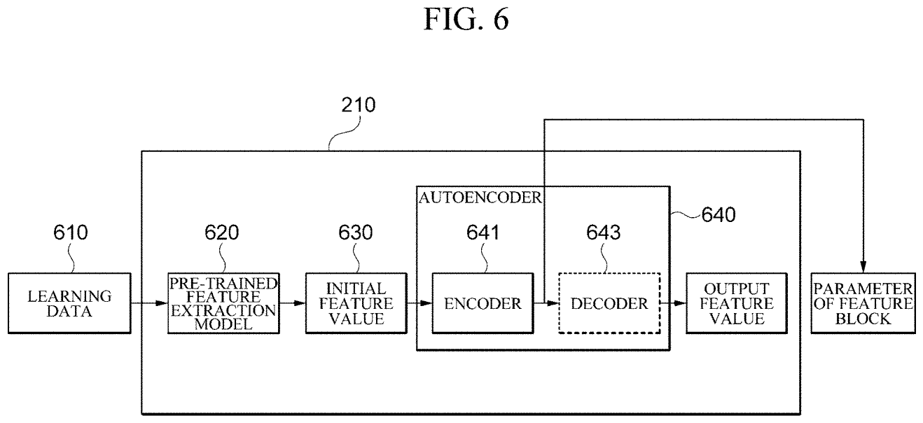

FIG. 6 is a diagram for describing an example of training a feature block 210 using an autoencoder 640 according to one embodiment.

Referring to FIG. 6, the computing device 12 may input a plurality of learning data 610 to the feature block 210.

Then, the computing device 12 may extract an initial feature value 630 for each of the plurality of learning data using the pre-trained feature extraction model 620.

Then, the computing device 12 may train the autoencoder 640 using the initial feature value 630 as learning data.

Here, the autoencoder 640 may refer to a neural network that is designed such that output data and input data are the same. Specifically, the autoencoder 640 may be a neural network that learns to find an encoding method that allows decoded output data to be the same as the input data when the input data is encoded and then the encoded data is decoded.

The autoencoder 640 may be composed of an encoder 641 including an input layer and a hidden layer and a decoder 643 including a hidden layer and an output layer. The autoencoder 640 may learn using the initial feature value 630 as input data such that a result value of a preset loss function Lₐₑ is minimized. In this case, the loss function Lₐₑ that is set up in the autoencoder 640 may be represented by Equation 2 below.

Lₐₑ=Σᵢ₌₁^{N}∥Fᵢ^{o}−AE(Fᵢ^{o})∥ₚ (2)

In Equation 2, N denotes the number of learning samples included in each of a plurality of learning data, Fᵢ^{o} denotes a feature value of an ith learning sample, AE denotes an output function of the decoder 643, and p denotes a parameter.

The autoencoder 640 may remove the decoder 643 after performing learning and may extract a feature value for each of the plurality of learning data using an output value of the decoder 641, that is, a parameter of the decoder 641.

Then, the computing device 12 may determine the parameter of the decoder 641 to be a parameter of the feature block 210.

Meanwhile, in the example described above, the feature block 210 is trained using the autoencoder, but is not necessarily limited thereto, and a method of training the feature block 210 may vary according to a type of a generative model.

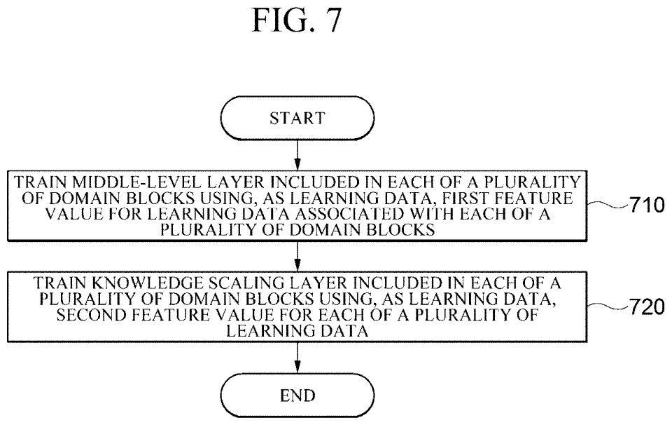

FIG. 7 is a flowchart illustrating a method of training a domain block 220 according to one embodiment.

The method illustrated in FIG. 7 may be performed by, for example, a computing device 12 which includes one or more processors and a memory in which one or more programs to be executed by the one or more processors are stored. In the illustrated flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

Referring to FIG. 7, the computing device 12 may train a middle-level layer included in each of a plurality of domain blocks 220 using a first feature value for learning data associated with each of the plurality of domain blocks 220 as learning data of the middle-level layer included in each of the plurality of domain blocks 220 (710).

For example, the computing device 12 may use the first feature value as input data of the middle-level layer and train the middle-level layer using, as target data, a label that is pre-assigned to the first feature value. In this case, the label may refer to output data that corresponds to the input data.

Then, the computing device 12 may train a knowledge scaling layer included in each of the plurality of domain blocks 220 using a second feature value for each of the plurality of learning data extracted using a parameter of the trained middle-level layer as training data of the knowledge scaling layer included in each of the plurality of domain blocks 220 (720).

For example, the computing device 12 may use a parameter of the trained middle-level layer to extract the second feature value for learning data associated with the domain block 220 that includes the corresponding middle-level layer. Thereafter, the computing device 12 may train the corresponding knowledge scaling layer using the extracted second feature value as learning data of the knowledge scaling layer included in the domain block 220 that includes the corresponding middle-level layer.

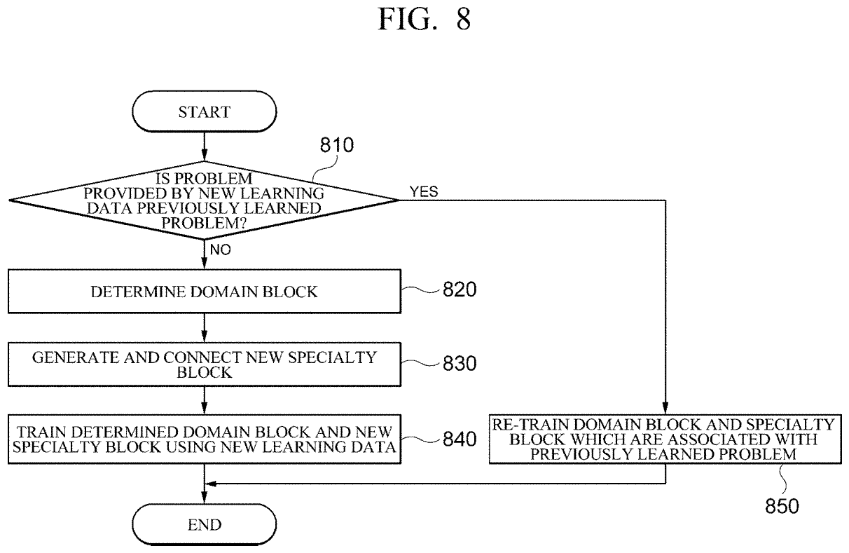

FIG. 8 is a flowchart illustrating a method of training a deep learning model according to an additional embodiment.

The method illustrated in FIG. 8 may be performed by, for example, a computing device 12 which includes one or more processors and a memory in which one or more programs to be executed by the one or more processors are stored. In the illustrated flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

Referring to FIG. 8, when new learning data that is not included in a plurality of learning data is input, the computing device 12 may determine whether a problem provided by the new learning data is a previously learned problem (810).

Then, when the problem provided by the new learning data is not a previously learned problem (810), the computing device 12 may determine a domain block 220 that is associated with the new learning data (820).

At this time, the computing device 12 may determine the domain block 220 using, for example, an entropy-based search algorithm, a distance-based search algorithm, a density-based search algorithm, or the like, but is not necessarily limited thereto, and a method of determining the domain block 220 may vary according to an embodiment.

Then, the computing device 12 may generate a new specialty block 230 associated with the new learning data and connect the new specialty block 230 to the determined domain block 220 (830).

Then, the computing device 12 may train the determined domain block 220 and the new specialty block 230 using the new learning data (840).

Meanwhile, when the problem provided by the new learning data is a previously learned problem (810), the computing device 12 may re-train a domain block 220 and a specialty block 230 which are associated with the previously learned problem using the new learning data (850).

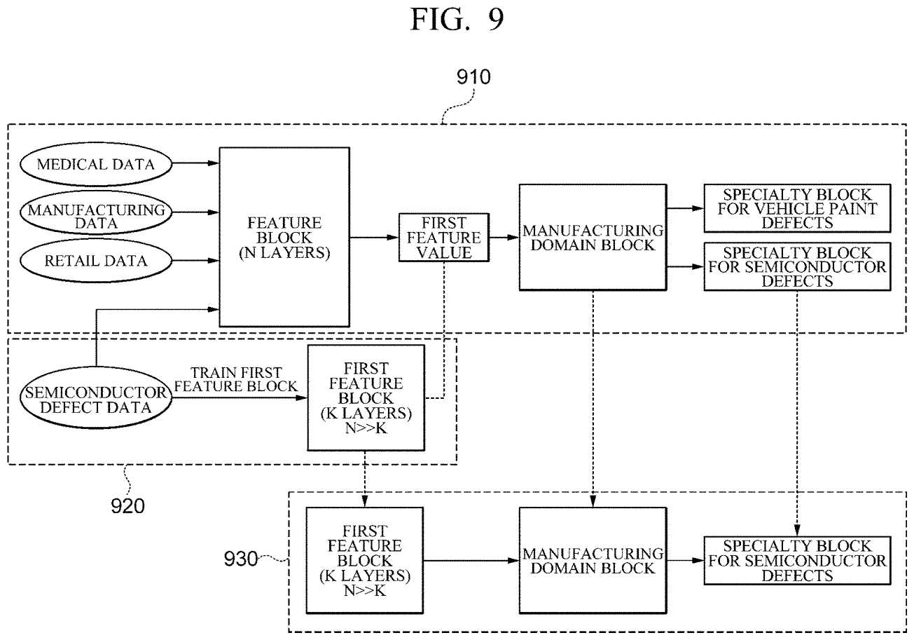

FIG. 9 is a diagram for describing an example of training a deep learning model 200 according to one embodiment.

For example, it is assumed that a user generates a deep learning model 200 for identifying semiconductor defects.

Referring to FIG. 9, the computing device 12 may perform initial training of the deep learning model 200 using a plurality of learning data including medical data, manufacturing data, retail data, and the like (910).

Then, the computing device 12 may extract a first feature value for semiconductor defect data by inputting the semiconductor defect data to an initially trained deep learning model 200. In this case, the first feature value for the semiconductor defect data may be a fixed value.

Then, the computing device 12 may generate a first feature block that is smaller than an existing block (920). In this case, the first feature block may mean a feature block that has fewer layers than the existing feature block.

In addition, the computing device 12 may train the first feature block using the semiconductor defect data as learning data through the same scheme as the scheme for training the above-described feature block.

Then, the computing device 12 may provide the user with a deep leaning model in which the trained first feature block is connected to a manufacturing domain block, as a semiconductor identification model (930).

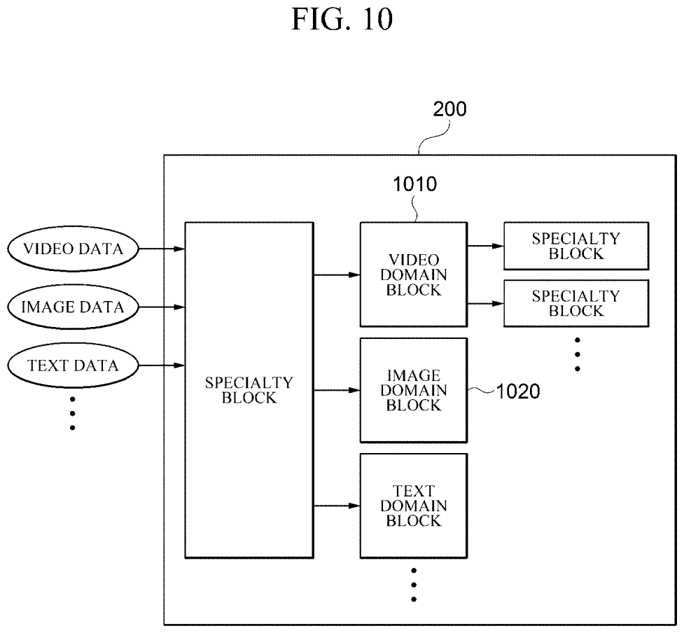

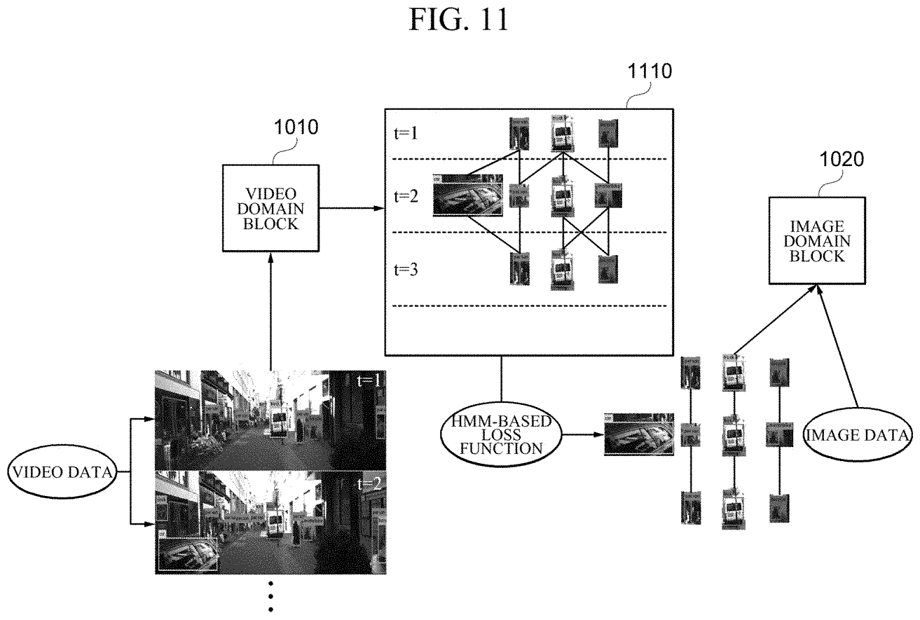

FIG. 10 is a diagram illustrating a configuration of a deep learning model 200 according to one embodiment. In addition, FIG. 11 is a diagram for describing another example of training the deep learning model 200 according to one embodiment.

Referring to FIGS. 10 and 11, the computing device 12 may train the deep learning model 200 including a video domain block 1010 and an image domain block 1020 using a plurality of learning data including video data, image data, text data, and the like.

In this case, the computing device 12 may extract images from input video data using the trained video domain block 1010. Also, the computing device 12 may generate a directed graph model 1110 in which the images are arranged in time order on the basis of time information included in the video data.

The directed graph model 1110 may be a model that extract various images from the vide data trained in the video domain block 1010 and then sequentially enumerates the extracted images on the basis of time information included in the video data. For example, the directed graph model 1110 may enumerate a plurality of images extracted when a time period is 1 second in specific video data and enumerate a plurality of images extracted when a time period is 2 seconds in specific video data. In this case, the directed graph model 1110 may information on a connection relationship between the plurality of images enumerated for each time period.

Then, the computing device 12 may train the directed graph model 1110 on the basis of, for example, hidden Markov model (HMM)-based loss function. In this case, a feature value extracted from the trained directed graph model 1110 may be used as learning data of the image domain block 1020. Thus, the image domain block 1020 is trained by inputting, as learning data, the feature value extracted from the trained directed graph model 1110 and the image data to the image domain block 1020, thereby increasing the image classification performance of the image domain block 1020.

In regard to the example of training the deep learning model 200, the above-described example describes that the image data extracted from the video data is used to train the image domain block 1020, but is not necessarily limited thereto. For example, the computing device 12 may identify objects included in each of a plurality of image data using the trained image domain block 1020. Thereafter, the computing device 12 may generate a directed graph model that sequentially connects and lists the identified objects and may train the video domain block 1010 using the generated directed graph model.

According to the disclosed embodiments, a deep learning model may be trained using learning data regarding problems of various fields so that there is an ample amount of data on which the model is trained and the performance of the trained model can be improved.

Also, according to the disclosed embodiments, since a variety of problems can be learned through a single deep learning model, it is possible to reduce computing resources used for models the number of which increases with the number of datasets.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of training a deep learning, which is performed by a computing device which includes one or more processors and a memory in which one or more programs to be executed by the one or more processors are stored, the method comprising:
training a feature block including a generative model using a plurality of learning data;
extracting a first feature value for each of the plurality of learning data using the trained feature block;
training a domain block associated with each of the plurality of learning data among a plurality of domain blocks using the first feature value as learning data;
extracting a second feature value for each of the plurality of learning data using the trained domain block; and
training a specialty block associated with each of the plurality of learning data, among a plurality of specialty blocks, which are connected to each of the plurality of domain blocks, using the second feature value.

2. The method of claim 1, wherein the training of the feature block comprises extracting an initial feature value for each of the plurality of learning data using a pre-trained feature extraction model and training the generative model using the initial feature value as learning data of the generative model and on the basis of a loss function which is set up in the generative model.

3. The method of claim 2, wherein the training of the feature block comprises determining a parameter of the trained generative model to be a parameter of the feature block.

4. The method of claim 3, wherein the extracting of the first feature value comprises extracting the first feature value using the parameter of the trained generative model.

5. The method of claim 1, wherein the training of the domain block comprises training each of the plurality of domain blocks such that a result value of a loss function set up in each of the plurality of domain blocks is minimized, wherein the result value of the loss function set up in each of the plurality of domain blocks corresponds to a sum of result values of loss functions, each of which is set up in each of the plurality of specialty blocks connected to each of the plurality of domain blocks.

6. The method of claim 1, wherein the domain block comprises a middle-level layer and a knowledge scaling layer.

7. The method of claim 6, wherein the training of the domain block comprises training the middle-level layer included in each of the plurality of domain blocks using the first feature value for learning data associated with each of the plurality of domain blocks as learning data of the middle-level layer included in each of the plurality of domain blocks.

8. The method of claim 7, wherein the extracting of the second feature value comprises extracting the second feature value using a parameter of the trained middle-level layer.

9. The method of claim 8, wherein the training of the domain block comprises training the knowledge scaling layer connected to each of the plurality of domain blocks using the second feature value, which is extracted using the parameter of the trained middle-level layer, as learning data of the knowledge scaling layer connected to each of the plurality of domain blocks.

10. The method of claim 9, wherein the training of the feature block comprises adjusting a parameter of the trained feature block for the domain block including the trained knowledge scaling layer on the basis of a scaling value of the trained knowledge scaling layer.

11. The method of claim 1, wherein the training of the domain block comprises re-training each of the plurality of domain blocks using a domain adversarial neural network and on the basis of a loss function set up in the domain adversarial neural network.

12. The method of claim 1, wherein the training of the specialty block comprises training a mask layer included in each of the plurality of specialty blocks and on the basis of a loss function set up in each of the plurality of specialty blocks and using the second feature value as learning data of the mask layer.

13. The method of claim 12, wherein the mask layer comprises a positive mask layer that extracts a feature value for learning data associated with the specialty block among learning data that are learned in the domain block connected to the specialty block and a negative mask layer that extracts a feature value for learning data that has a negative effect on the specialty block among learning data that are learned in the domain block connected to the specialty block.

14. The method of claim 1, further comprising, when new learning data that is not included in the plurality of learning data is input, determining whether a problem provided by the new learning data is a previously learned problem.

15. The method of claim 14, further comprising:
when the problem provided by the new learning data is not a previously learned problem, determining a domain block associated with the new learning data;
generating a new specialty block associated with the new learning data and connecting the new specialty block to the determined domain block; and
training the determined domain block and the new specialty block using the new learning data.

16. The method of claim 14, further comprising, when the problem provided by the new learning data is a previously learned problem, re-training a domain block and a specialty block that are associated with the previously learned problem using the new learning data.

17. An apparatus for training a deep learning model, comprising:
one or more processors;
a memory; and
one or more programs,
wherein the one or more programs are stored in the memory and are configured to be executed by the one or more processors and
the one or more programs comprise commands for
training a feature block including a generative model using a plurality of learning data,
extracting a first feature value for each of the plurality of learning data using the trained feature block,
training a domain block associated with each of the plurality of learning data among a plurality of domain blocks using the first feature value as learning data,
extracting a second feature value for each of the plurality of learning data using the trained domain block, and
training a specialty block associated with each of the plurality of learning data, among a plurality of specialty blocks, which are connected to each of the plurality of domain blocks, using the second feature value.

18. The apparatus of claim 17, wherein the training of the feature block comprises extracting an initial feature value for each of the plurality of learning data using a pre-trained feature extraction model and training the generative model using the initial feature value as learning data of the generative model and on the basis of a loss function which is set up in the generative model.

19. The apparatus of claim 18, wherein the training of the feature block comprises determining a parameter of the trained generative model to be a parameter of the feature block.

20. The apparatus of claim 19, wherein the extracting of the first feature value comprises extracting the first feature value using the parameter of the trained generative model.

21. The apparatus of claim 17, wherein the training of the domain block comprises training each of the plurality of domain blocks such that a result value of a loss function set up in each of the plurality of domain blocks is minimized, wherein the result value of the loss function set up in each of the plurality of domain blocks corresponds to a sum of result values of loss functions, each of which is set up in each of the plurality of specialty blocks connected to each of the plurality of domain blocks.

22. The apparatus of claim 17, wherein the domain block comprises a middle-level layer and a knowledge scaling layer.

23. The apparatus of claim 22, wherein the training of the domain block comprises training the middle-level layer included in each of the plurality of domain blocks using the first feature value for learning data associated with each of the plurality of domain blocks as learning data of the middle-level layer included in each of the plurality of domain blocks.

24. The apparatus of claim 23, wherein the extracting of the second feature value comprises extracting the second feature value using a parameter of the trained middle-level layer.

25. The apparatus of claim 24, wherein the training of the domain block comprises training the knowledge scaling layer connected to each of the plurality of domain blocks using the second feature value, which is extracted using the parameter of the trained middle-level layer, as learning data of the knowledge scaling layer connected to each of the plurality of domain blocks.

26. The apparatus of claim 25, wherein the training of the feature block comprises adjusting a parameter of the trained feature block for the domain block including the trained knowledge scaling layer on the basis of a scaling value of the trained knowledge scaling layer.

27. The apparatus of claim 17, wherein the training of the domain block comprises re-training each of the plurality of domain blocks using a domain adversarial neural network and on the basis of a loss function set up in the domain adversarial neural network.

28. The apparatus of claim 17, wherein the training of the specialty block comprises training a mask layer included in each of the plurality of specialty blocks and on the basis of a loss function set up in each of the plurality of specialty blocks and using the second feature value as learning data of the mask layer.

29. The apparatus of claim 28, wherein the mask layer includes a positive mask layer that extracts a feature value for learning data associated with the specialty block among learning data that are learned in the domain block connected to the specialty block and a negative mask layer that extracts a feature value for learning data that has a negative effect on the specialty block among learning data that are learned in the domain block connected to the specialty block.

30. The apparatus of claim 17, wherein the one or more programs further comprise commands for, when new learning data that is not included in the plurality of learning data is input, determining whether a problem provided by the new learning data is a previously learned problem.

31. The apparatus of claim 30, wherein the one or more programs further comprise commands for, when the problem provided by the new learning data is not a previously learned problem, determining a domain block associated with the new learning data, generating a new specialty block associated with the new learning data and connecting the new specialty block to the determined domain block, and training the determined domain block and the new specialty block using the new learning data.

32. The apparatus of claim 30, wherein the one or more programs further comprise commands for, when the problem provided by the new learning data is a previously learned problem, re-training a domain block and a specialty block that are associated with the previously learned problem using the new learning data.
